(19) United States
(12) Patent Application Publication
(10) Pub. No.: US 2026/0365499 A1
(43) Pub. Date: Nov. 19, 2026

(54) VEHICLE JACK WITH IMPROVED LIFTING HEAD AND INTERLOCKING LIFTING PADS

(71) Applicant: Cody Fullmer, Layton, UT (US)

(72) Inventor: Cody Fullmer, Layton, UT (US)

(21) Appl. No.: 19/207,812

(22) Filed: May 14, 2025

(51) Int. Cl. B66F 3/36; B66F 3/12

(52) U.S. Cl. CPC B66F 3/36; B66F 3/12

(57) ABSTRACT

A vehicle jack is provided with a lifting head that safely and securely lifts vehicles by a designated lifting points such as a lifting point recess or a designated pinch weld location along the vehicle frame. The jack lifting head is usable with lifting pads that include a lower recess that receives and interlocks with the jack lifting head and an upper projection that fits into a lifting point recess on a vehicle. The tops of the lifting pads have a shaped lifting structure that engages lifting recesses and locations such as frames or cross members to allow a person greater versatility in using the jack while still increasing the safety and stability in using the vehicle jack.

### THE FIELD OF THE INVENTION

The present invention relates to automobile jacks. In particular, examples of the present invention relate to an automobile jack with an improved lifting head and interlocking lifting pads.

### INTRODUCTION

Automobile lifting jacks such as the compact emergency scissor jacks provided for changing a flat tire inadequately support the vehicle. Many vehicles are designed to be lifted on a pinch weld along the lower vehicle frame. The vehicles are lifted at a reinforced joint where a vertical pillar such as the vehicle A or C pillar join the lower frame rail. Jack lifting heads do not adequately support the vehicle frame rail when lifting the vehicle and the pinch weld is often damaged by the jack. Additionally, the jack lifting head does not secure the frame rail and pinch weld adequately against slipping. Some luxury vehicles are manufactured with lifting points with a shaped recess that receive a specialized lifting head shape. Lifting jacks that are not designed specifically for the vehicle are not safe to use and may damage the vehicle because they do not properly fit into the vehicle recess and may slip and fail when lifting the vehicle. Vehicles must be properly lifted and supported at a lifting point as other locations on the vehicle are not sufficiently strong to support the weight of the vehicle. Lifting at a location other than the designated lifting point will typically damage the vehicle.

### BRIEF DESCRIPTION OF THE DRAWINGS

Non-limiting and non-exhaustive examples of the present invention are described with reference to the following figures, wherein like reference numerals refer to like parts throughout the various views unless otherwise specified.

FIG. 1 is a drawing of a vehicle lifting jack.

FIG. 2 is a perspective drawing the jack lifting head.

FIG. 3 is a front view drawing of the jack lifting head and a vehicle lifting point.

FIG. 4 is a front view drawing of the jack lifting head.

FIG. 5 is a back view drawing of the jack lifting head.

FIG. 6 is a left side view drawing of the jack lifting head.

FIG. 7 is a right side view drawing of the jack lifting head.

FIG. 8 is a top view drawing of the jack lifting head.

FIG. 9 is a bottom view drawing of the jack lifting head.

FIG. 10 is a top perspective view drawing of an example jack lifting pad.

FIG. 11 is a bottom perspective view drawing of the jack lifting pad of FIG. 10.

FIG. 12 is a side view drawing of the jack lifting pad of FIG. 10.

FIG. 13 is a top view drawing of the jack lifting pad of FIG. 10.

FIG. 14 is a bottom view drawing of the jack lifting pad of FIG. 10.

FIG. 15 is a top perspective view drawing of another example jack lifting pad.

FIG. 16 is a bottom perspective view drawing of the jack lifting pad of FIG. 15.

FIG. 17 is a left side view drawing of the jack lifting pad of FIG. 15.

FIG. 18 is a front view drawing of the jack lifting pad of FIG. 15.

FIG. 19 is a top view drawing of the jack lifting pad of FIG. 15.

FIG. 20 is a bottom view drawing of the jack lifting pad of FIG. 15.

FIG. 21 is a top perspective view drawing of another example jack lifting pad.

FIG. 22 is a bottom perspective view drawing of the jack lifting pad of FIG. 21.

FIG. 23 is a left side view drawing of the jack lifting pad of FIG. 21.

FIG. 24 is a front view drawing of the jack lifting pad of FIG. 21.

FIG. 25 is a top view drawing of the jack lifting pad of FIG. 21.

FIG. 26 is a bottom view drawing of the jack lifting pad of FIG. 21.

FIG. 27 is a top perspective view drawing of another example jack lifting pad.

FIG. 28 is a bottom perspective view drawing of the jack lifting pad of FIG. 27.

FIG. 29 is a left side view drawing of the jack lifting pad of FIG. 27.

FIG. 30 is a front view drawing of the jack lifting pad of FIG. 27.

FIG. 31 is a top view drawing of the jack lifting pad of FIG. 27.

FIG. 32 is a bottom view drawing of the jack lifting pad of FIG. 27.

Corresponding reference characters indicate corresponding components throughout the several views of the drawings. Unless otherwise noted, the drawings have been drawn to scale. Skilled artisans will appreciate that elements in the figures are illustrated for simplicity and clarity. For example, the dimensions of some of the elements in the figures may be exaggerated relative to other elements to help improve understanding of various examples of the present invention. Also, common but well-understood elements that are useful or necessary in a commercially feasible embodiment are often not depicted in order to facilitate a less obstructed view of these various embodiments of the present invention.

It will be appreciated that the drawings are illustrative and not limiting of the scope of the invention which is defined by the appended claims. The examples shown each accomplish various different advantages. It is appreciated that it is not possible to clearly show each element or advantage in a single figure, and as such, multiple figures are presented to separately illustrate the various details of the examples in greater clarity. Similarly, not every example need accomplish all advantages of the present disclosure.

### DETAILED DESCRIPTION

In the following description, numerous specific details are set forth in order to provide a thorough understanding of the present invention. It will be apparent, however, to one having ordinary skill in the art that the specific detail need not be employed to practice the present invention. In other instances, well-known materials or methods have not been described in detail in order to avoid obscuring the present invention.

In the above disclosure, reference has been made to the accompanying drawings, which form a part hereof, and in which are shown by way of illustration specific implementations in which the disclosure may be practiced. It is understood that other implementations may be utilized and structural changes may be made without departing from the scope of the present disclosure. References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, such feature, structure, or characteristic may be used in connection with other embodiments whether or not explicitly described. The particular features, structures or characteristics may be combined in any suitable combination and/or sub-combinations in one or more embodiments or examples. It is appreciated that the figures provided herewith are for explanation purposes to persons ordinarily skilled in the art.

As used herein, “adjacent” refers to near or close sufficient to achieve a desired effect. Although direct contact is common, adjacent can broadly allow for spaced apart features. As used herein, the singular forms “a,” and, “the” include plural referents unless the context clearly dictates otherwise.

As used herein, the term “substantially” refers to the complete or nearly complete extent or degree of an action, characteristic, property, state, structure, item, or result. For example, an object that is “substantially” enclosed would mean that the object is either completely enclosed or nearly completely enclosed. The exact allowable degree of deviation from absolute completeness may in some cases depend on the specific context. However, generally speaking the nearness of completion will be such as to have the same overall result as if absolute and total completion were obtained. The use of “substantially” is equally applicable when used in a negative connotation to refer to the complete or near complete lack of an action, characteristic, property, state, structure, item, or result. For example, a composition that is “substantially free of” particles would either completely lack particles, or so nearly completely lack particles that the effect would be the same as if it completely lacked particles. In other words, a composition that is “substantially free of” an ingredient or element may still actually contain such item as long as there is no measurable effect thereof.

As used herein, the term “about” is used to provide flexibility to a number or numerical range endpoint by providing that a given value may be one or two significant digits above or one or two significant digits below the number or endpoint.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary.

Dimensions, amounts, and other numerical data may be expressed or presented herein in a range format. It is to be understood that such a range format is used merely for convenience and brevity and thus should be interpreted flexibly to include not only the numerical values explicitly recited as the limits of the range, but also to include all the individual numerical values or sub-ranges encompassed within that range as if each numerical value and sub-range is explicitly recited. As an illustration, a numerical range of “about 1 to about 5” should be interpreted to include not only the explicitly recited values of about 1 to about 5, but also include individual values and sub-ranges within the indicated range.

The disclosure particularly describes a universal automotive lifting jack that works with all vehicle lifting points. The lifting jack includes a lifting head designed to properly support a vehicle frame at a pinch weld lifting point by both properly supporting the vehicle frame and by securing the pinch weld within the lifting head. The lifting head also fits inside of rectangular recessed lifting points of multiple sizes as are common on German vehicles. For other vehicles using recessed lifting points such as round or cylindrical recesses, the jack lifting head is used with a lifting pad that interlocks with the jack lifting head and engages the vehicle recessed lifting point.

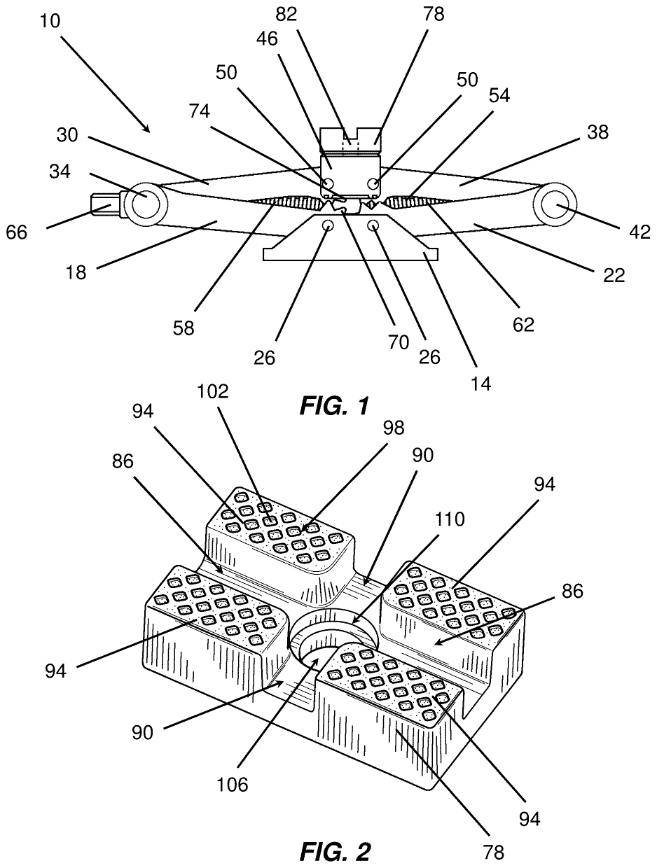

Turning now to FIG. 1, a side view of an example vehicle scissor jack 10 is shown. The scissor jack 10 includes a base or foot 14 that supports the jack 10 and a vehicle during use of the jack. The jack 10 includes a lifting mechanism and an upper lifting portion and the lifting mechanism is operable to move the lifting portion away from the base to lift a vehicle away from the base and away from the ground or surface on which the vehicle rests. The example jack 10 is a scissor jack with a top lifting bracket and the lifting mechanism includes lifting arms and a jack screw that move the top bracket away from the base when operated. The A left lower lifting arm 18 and a right lower lifting arm 22 are attached to the base 14 at pivot joints 26. The left lower lifting arm 18 is attached to a left upper lifting arm 30 at a left jack screw trunnion 34. The right lower lifting arm 22 is attached to a left upper lifting arm 38 at a right jack screw trunnion 42. The left upper lifting arm 30 and the right upper lifting arm 38 are attached to a top bracket 46 at pivot joints 50. A jack screw 54 passes through the left jack screw trunnion 34 and the right jack screw trunnion 42. The jack screw 54 includes a left hand threaded section 58 and a right hand threaded section 62 such that the left jack screw trunnion 34 and the right jack screw trunnion 42 are moved towards the center of the jack as the screw 54 is turned clockwise; thereby moving the top bracket 46 away from the foot 14 to operate the jack 10. The jack screw 54 includes a drive end 66 that is turned by a wrench or other tool to rotate the jack screw 54 and operate the jack 10.

The inboard ends of the left lower lifting arm 18 and the right lower lifting arm 22 are formed with gear teeth 70 that engage each other so that the left lower lifting arm 18 and the right lower lifting arm 22 rotate equally as the jack 10 is operated. Similarly, the inboard ends of the left upper lifting arm 30 and the right upper lifting arm 38 are formed with gear teeth 74 that engage each other so that the left upper lifting arm 30 and the right upper lifting arm 38 rotate equally as the jack 10 is operated.

A jack lifting head 78 is attached to the top bracket 46, such as by pin 82. The jack lifting head 78 engages the vehicle lifting points and properly supports the vehicle for safe lifting of the vehicle to perform maintenance such as changing a tire. The bottom face of the jack lifting head 78 is flat and is supported by the flat upper surface of the top bracket 46. FIG. 2 shows a perspective view of the jack lifting head 78. The jack lifting head 78 has an overall rectangular shape. The jack lifting head 78 has a length which is about 5 cm and a width which is about 3 cm. Such a size and shape of a jack lifting head 78 has been determined to safely lift a majority of vehicles using a rectangularly shaped lifting point recess and also adequately support a vehicle by a frame pinch weld lifting point. The jack lifting head 78 is formed with a longitudinal channel 86 that extends across the top face of the jack lifting head between the two opposing sides of the jack lifting head 78. The longitudinal channel 86 extends through the center of the top face of the jack lifting head 78. The longitudinal channel 86 is about 8 mm deep and between about 8 mm and about 10 mm wide, and has a depth that is about 60 percent of the thickness of the jack lifting head 78. The jack lifting head 78 also includes a transverse channel 90 that extends across the top face of the jack lifting head 78 between the front and the back sides of the jack lifting head 78. The transverse channel 90 extends through the center of the top face of the jack lifting head 78 and is about 8 mm deep and between about 8 mm and about 10 mm wide with a depth that is about 60 percent of the thickness of the jack lifting head 78. The longitudinal channel 86 and the transverse channel 90 are orthogonal to each other when viewed from the top of the jack lifting head 78 and intersect each other at the center of the jack lifting head 78. The longitudinal channel 86 and the transverse channel 90 extend through the front, back, and side walls of the jack lifting head 78.

The jack lifting head 78 includes four rectangular lifting blocks 94 located at the corners of the jack lifting head 78. The four rectangular lifting blocks are separated from each other by the longitudinal channel 86 and the transverse channel 90. The jack lifting head 78 is made of a durable rigid polymer material and is solid throughout the lifting head 78. Particularly, the rectangular lifting blocks 94 are formed from solid material between the bottom surface of the jack lifting head 78 and the top lifting surface of the rectangular lifting blocks 94. Each of the rectangular lifting blocks 94 have a textured non-slip top lifting surface 98 that includes raised and recessed surface features such as recessed gripping cups 102 with raised surface features located between adjacent gripping cups 102. The jack lifting head 78 includes a central mounting hole 106 that extends vertically through the center of the jack lifting head 78. Mounting hole 106 includes a cylindrical through hole and a recessed upper shoulder 110 that receive a shouldered attachment pin 82 to attach the jack lifting pad 78 to the top bracket 46.

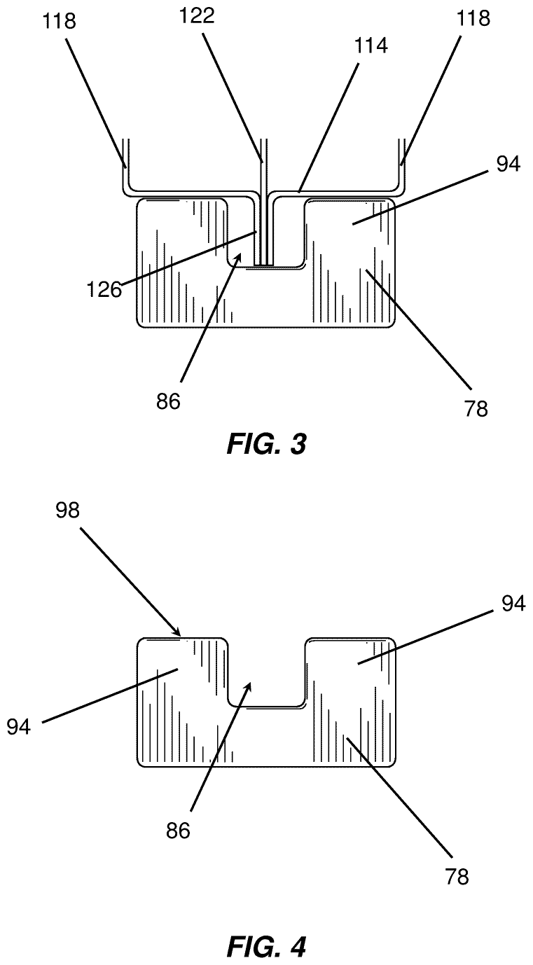

FIG. 3 shows a side view of the jack lifting head 78 and the frame rail lifting point 114 of a vehicle. The frame rail lifting point 114 is shown in cross section to illustrate the functionality of the hack lifting head 78. Automobile frame rail lifting points 114 typically include formed sheet metal frame sections 118 of the automobile frame and additional sheet metal pillar sections 122 such as the sheet metal from the A-pillar of the automobile that are all attached together at a pinch weld 126. The jack lifting head 78 receives and supports the pinch weld 126 in the channel 86 (or 90) and supports the frame rail with the rectangular lifting blocks 94. The textured upper surface of the rectangular lifting blocks 94 better grip a dirty frame rail and keep the automobile stable on the lifting jack. The pinch weld is supported by and contained within the channel 86, 90 to further stabilize the vehicle and avoid movement of the vehicle while the vehicle is supported by the jack.

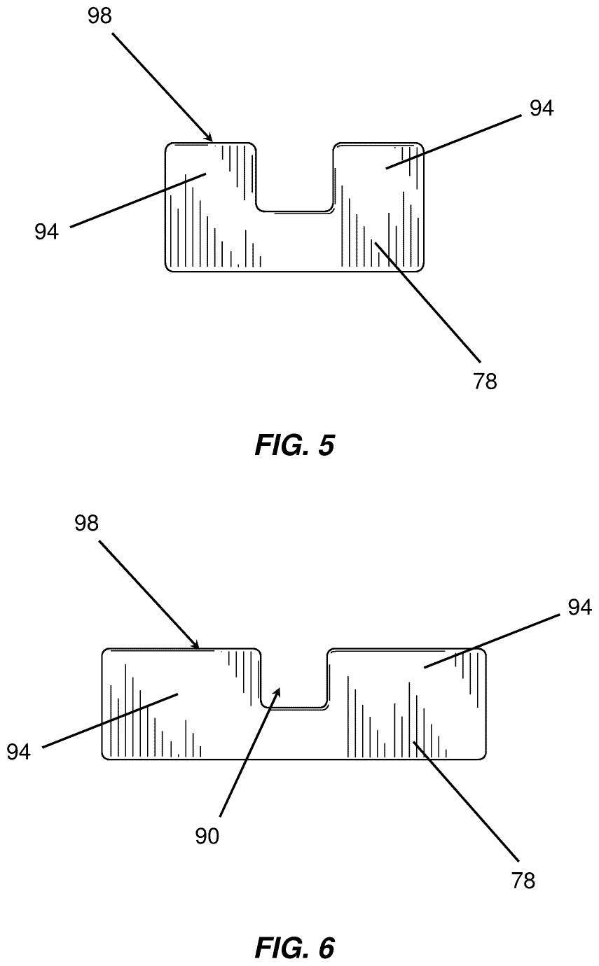

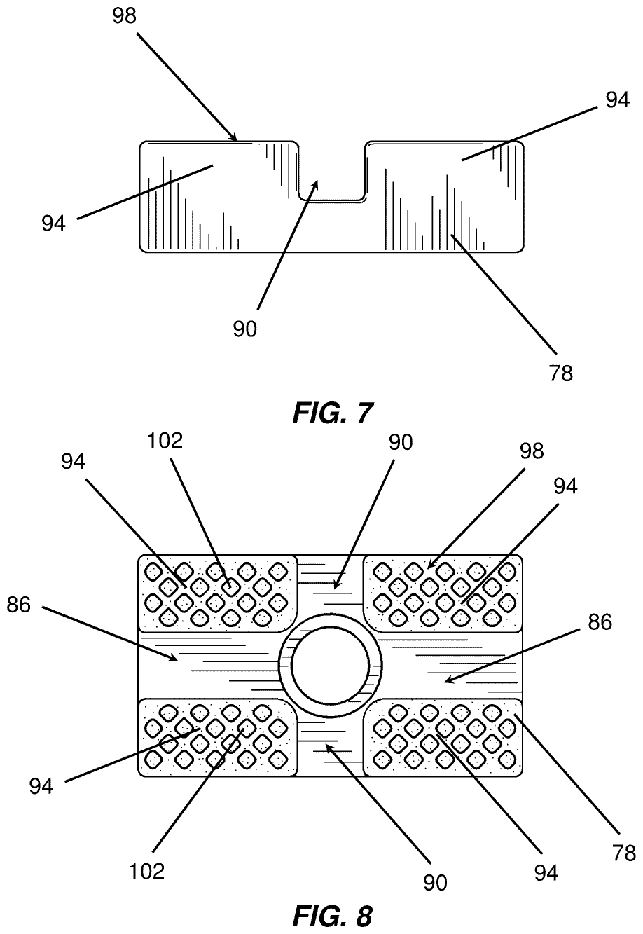

FIG. 4 shows a front view of the jack lifting head 78. FIG. 5 shows a back view of the jack lifting head 78. The longitudinal channel 86 extends down through the upper lifting surface 98 of the jack lifting head 78 and extends through the front and back faces of the jack lifting head 78. FIG. 6 shows a left side view of the jack lifting head 78. FIG. 7 shows a right side view of the jack lifting head 78. The transverse channel 86 extends down through the upper lifting surface 98 of the jack lifting head 78 and extends through the left and right faces of the jack lifting head 78. The front, back, left, and right sides of the jack lifting head are perpendicular to the bottom face or upper lifting surface 98 except for a small draft angle used to facilitate molding the jack lifting head 78.

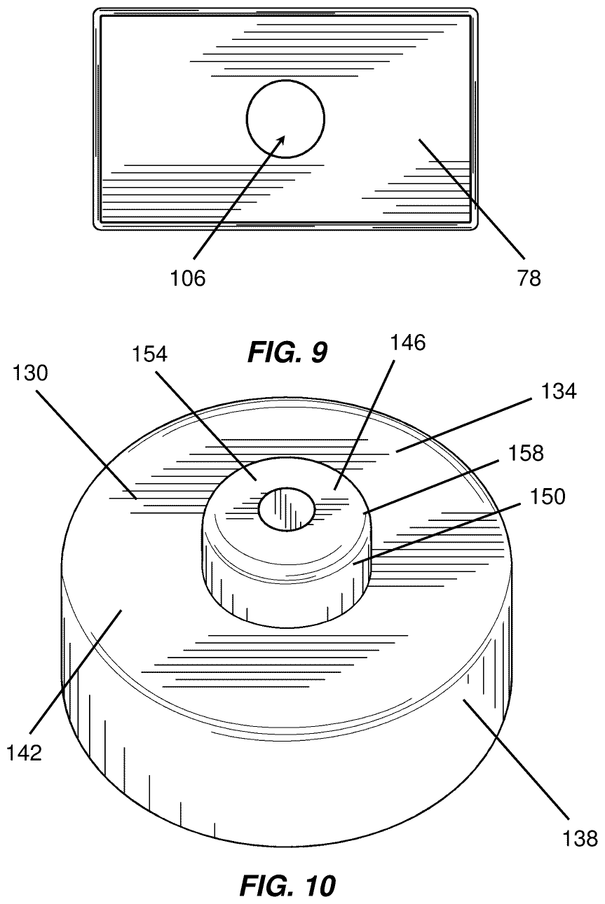

FIG. 8 shows a top view of the jack lifting head 78. It can be seen how the longitudinal channel 86 and the transverse channel 90 extend across the middle of the top face of the jack lifting head 78 at right angles to each other and extend through the respective front, back, left, and right sides of the jack lifting head 78. The central mounting hole 106 extends vertically through the center of the jack lifting head 78 between the four rectangular lifting blocks 94 and within the channel created by the longitudinal channel 86 and the transverse channel 90. When installed, the attachment pin 82 is slightly recessed from the bottom surfaces of the longitudinal channel 86 and the transverse channel 90. FIG. 9 shows a bottom view of the jack lifting head. The bottom surface of the jack lifting head 78 is flat with eased or rounded edges. The central hole 106 extends through the jack lifting head to receive the attachment pin 82.

FIGS. 10 through 14 show an example jack lifting pad 130 that is used in combination with the jack 10 and jack lifting head 78 to lift automobiles with specialized recesses at lifting points. FIG. 10 shows a top perspective view of the jack lifting pad 130. The jack lifting pad 130 is used with automobiles that are manufactured with a specialized recess at lifting points. The example lifting pad 130 includes a cylindrical body 134 that includes a cylindrical side wall 138 and a flat upper surface 142. The jack lifting pad 130 includes a shaped projection 146 that extends from the upper surface 142 of the lifting pad body 134. The shaped projection 146 is sized and configured to be matingly received into a vehicle lifting point recess. The example shaped projection 146 is a cylindrical projection with a straight cylindrical sidewall 150, flat top 154, and rounded upper shoulder 158.

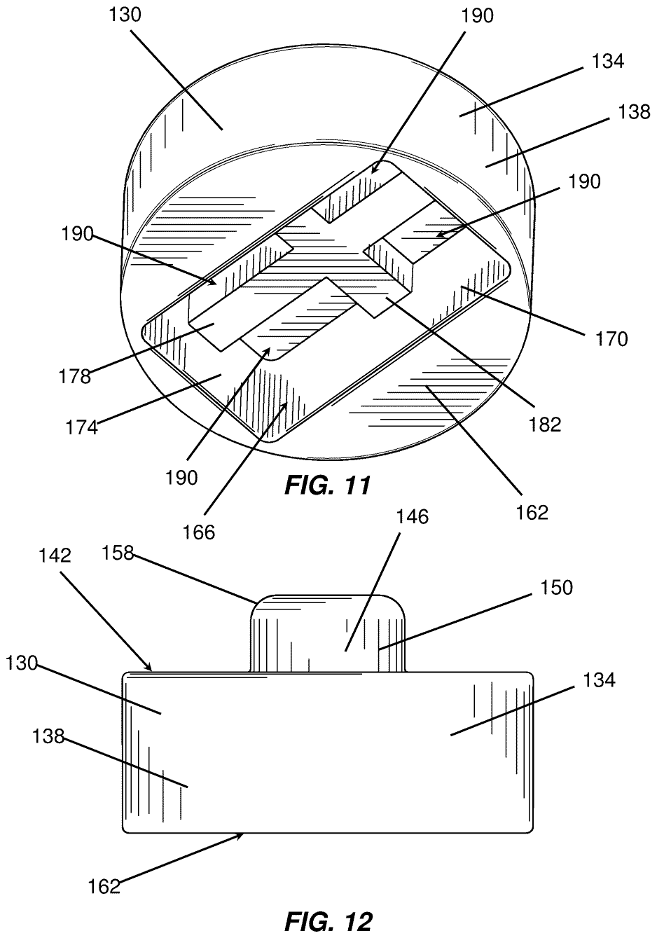

FIG. 11 shows a bottom perspective view of the jack lifting pad 130. The bottom of the jack lifting pad 130 has a flat lower surface 162 and an interlocking jack recess 166 that receives the jack lifting head 78 and that interlocks with the jack lifting head 78 to secure the lifting pad 130 to the jack lifting head 78. The jack recess 166 includes longitudinal side walls 170 and front and back end walls 174 that are close fitting to the jack lifting head side walls and front and back walls when the jack lifting head 78 is disposed in the jack recess 166. The jack recess 166 includes a longitudinal wall 178 and a transverse wall 182 that extend across the length of the jack recess upper end and extend downwardly from the jack recess upper surface. The longitudinal wall 178 and transverse wall 182 extend across center lines of the jack recess upper surface such that the longitudinal wall is equally spaced between the longitudinal sidewalls 170 and parallel to the side walls. Similarly, the transverse wall 182 is equally spaced between the front and back end walls 174 and is parallel to the front and back end walls 174. The longitudinal wall 178 and transverse wall 182 extend downwardly from the jack recess upper surface by the same distances and are slightly smaller in width and height than the longitudinal channel 86 and the transverse channel 90. The longitudinal wall 178 and transverse wall 182 are received in the longitudinal channel 86 and the transverse channel 90 respectively when the jack lifting pad 130 is attached to the jack lifting head 78 by inserting the jack lifting head 78 into the jack recess 166. The jack recess 166 includes four rectangular lifting recesses 190 located at the corners of the jack recess 166. The four rectangular lifting recesses 190 are separated from each other by the longitudinal wall 178 and transverse wall 182. The rectangular lifting blocks 94 are matingly received in the rectangular lifting recesses 190 when the jack lifting pad 130 is attached to the jack lifting head 78 by inserting the jack lifting head 78 into the jack recess 166. The sides of the rectangular lifting recesses 190 are positioned closely to the sides of the rectangular lifting blocks 94 to prevent movement of the jack lifting pad 130 and the top lifting surfaces 98 of the rectangular lifting blocks 94 contact the upper surfaces of the rectangular lifting recesses 190 so that the weight of the vehicle is carried by the jack lifting pad 130 and transmitted to the jack 10 by the jack lifting pad 130 and jack lifting head 78. The jack recess 166 has a shape that is complementary to the shape of the jack lifting head 78 and includes interlocking features that engage complementary features on the jack lifting head. The jack lifting pad 130 is made of a durable rigid polymer material and is solid throughout the lifting pad 130.

FIG. 12 shows a side view of the jack lifting pad 130. The drawing illustrates the cylindrical body 134 with its cylindrical side wall 138, flat upper surface 142, and flat lower surface 162 as well as the shaped projection 146 with its straight cylindrical sidewall 150, flat top 154, and rounded upper shoulder 158. The example lifting pad 130 is axially symmetric about a vertical axis except for the jack recess 166 and the front, back, left, and right side views are identical.

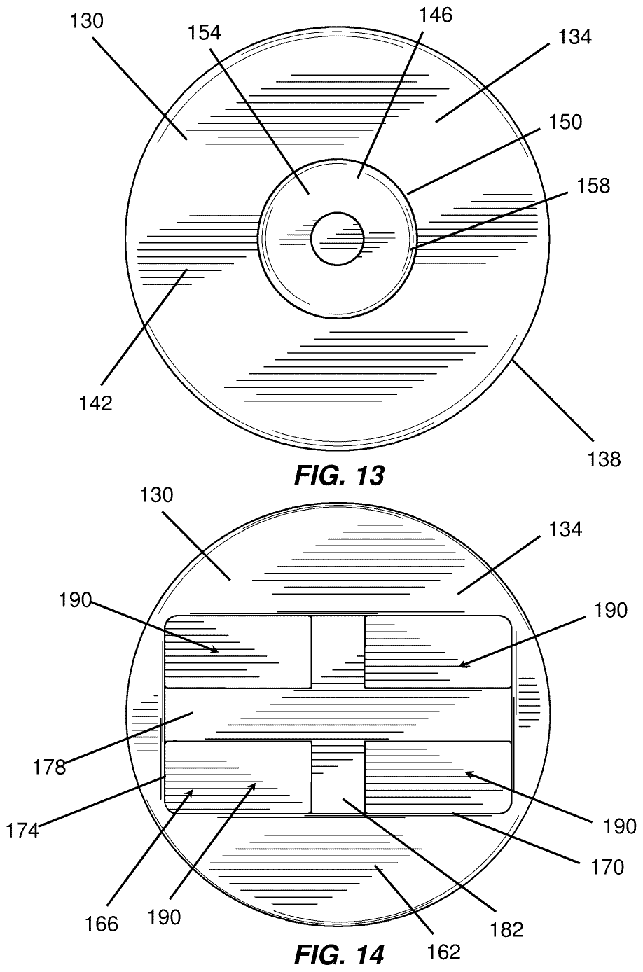

FIG. 13 shows a top view of the jack lifting pad 130, illustrating the cylindrical body 134 and cylindrical side wall 138. The flat upper surface 142 forms a broad area for supporting the vehicle and the shaped projection 146 engages the vehicle lifting point recess to prevent the lifting pad from shifting position relative to the vehicle. FIG. 14 shows a bottom view of the jack lifting pad 130 and the interlocking jack recess 166 that receives the jack lifting head. The jack recess 166 is a close fitting mating fit to the jack lifting head 78.

In use, the jack lifting pad 130 is used to lift the automobile by inserting the shaped projection 146 into a correspondingly shaped recess of a vehicle lifting point. The shaped projection 146 contacts the recess to center the jack lifting pad 130 on the vehicle lifting point. The upper surface 142 contacts the vehicle lifting point and the upper surface 142 and shaped projection 146 support the weight of the vehicle.

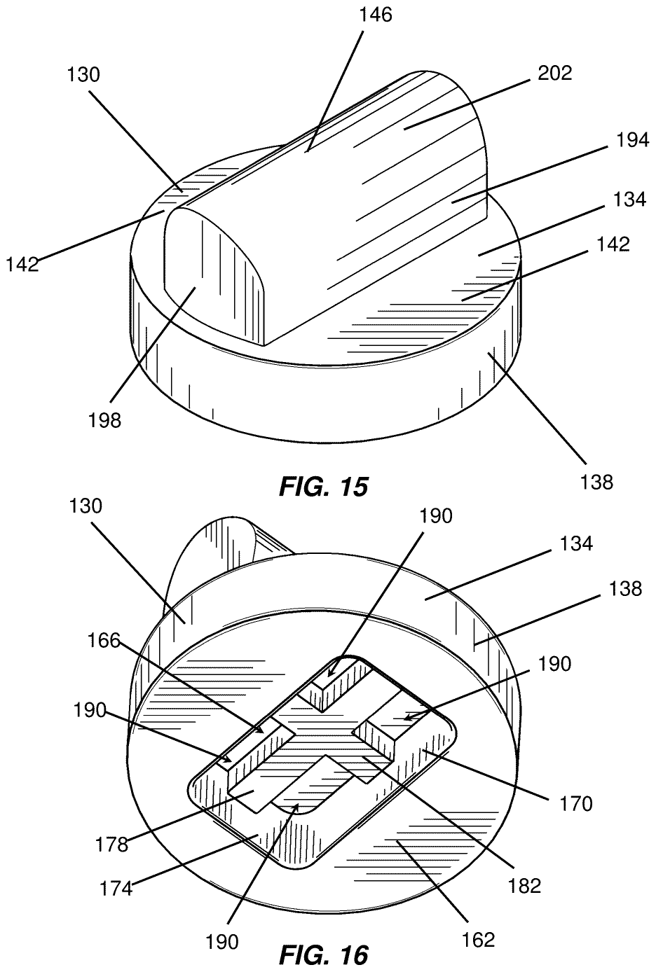

FIGS. 15 through 20 show another example jack lifting pad 130. FIG. 15 shows a top perspective view of the example jack lifting pad 130. The jack lifting pad 130 is used with automobiles that are manufactured with a specialized recess at lifting points. The example lifting pad 130 includes a cylindrical body 134 that includes a cylindrical side wall 138 and a flat upper surface 142. The jack lifting pad 130 includes a shaped projection 146 that extends from the upper surface 142 of the lifting pad body 134. The shaped projection 146 is sized and configured to be matingly received into a specialized vehicle lifting point recess. The example shaped projection 146 is a rectangular projection with a horizontally arranged semi-cylindrical upper surface. The shaped projection 146 includes flat vertical side wall sections 194 and vertical end walls 198. The end walls 198 are straight in the vertical direction and are curved in the horizontal direction to create a rounded wall. The end walls 198 are curved so that they have a circular horizontal cross-section that is parallel to the circular body 134. In some examples, the end walls 198 may be flat. The shaped projection 146 includes a curved upper surface 202 that is a semi cylinder with a horizontally arranged axis. The curved upper surface is tangent to and extends smoothly from the side walls 194 and curved across the top of the shaped projection 146. In the example lifting pad 130, the shaped projection extends with its long direction perpendicular to the long direction of the interlocking jack recess 166 on the bottom of the lifting pad 130.

FIG. 16 shows a bottom perspective view of the jack lifting pad 130. The bottom of the jack lifting pad 130 has a flat lower surface 162 and an interlocking jack recess 166 that receives the jack lifting head 78 and that interlocks with the jack lifting head 78 to secure the lifting pad 130 to the jack lifting head 78. The jack recess 166 includes longitudinal side walls 170 and front and back end walls 174 that are close fitting to the jack lifting head side walls and front and back walls when the jack lifting head 78 is disposed in the jack recess 166. The jack recess 166 includes a longitudinal wall 178 and a transverse wall 182 that extend across the length of the jack recess upper end and extend downwardly from the jack recess upper surface. The longitudinal wall 178 and transverse wall 182 extend across center lines of the jack recess upper surface such that the longitudinal wall is equally spaced between the longitudinal sidewalls 170 and parallel to the side walls. Similarly, the transverse wall 182 is equally spaced between the front and back end walls 174 and is parallel to the front and back end walls 174. The longitudinal wall 178 and transverse wall 182 extend downwardly from the jack recess upper surface by the same distances and are slightly smaller in width and height than the longitudinal channel 86 and the transverse channel 90. The longitudinal wall 178 and transverse wall 182 are received in the longitudinal channel 86 and the transverse channel 90 respectively when the jack lifting pad 130 is attached to the jack lifting head 78 by inserting the jack lifting head 78 into the jack recess 166. The jack recess 166 includes four rectangular lifting recesses 190 located at the corners of the jack recess 166. The four rectangular lifting recesses 190 are separated from each other by the longitudinal wall 178 and transverse wall 182. The rectangular lifting blocks 94 are matingly received in the rectangular lifting recesses 190 when the jack lifting pad 130 is attached to the jack lifting head 78 by inserting the jack lifting head 78 into the jack recess 166. The sides of the rectangular lifting recesses 190 are positioned closely to the sides of the rectangular lifting blocks 94 to prevent movement of the jack lifting pad 130 and the top lifting surfaces 98 of the rectangular lifting blocks 94 contact the upper surfaces of the rectangular lifting recesses 190 so that the weight of the vehicle is carried by the jack lifting pad 130 and transmitted to the jack 10 by the jack lifting pad 130 and jack lifting head 78. The jack recess 166 has a shape that is complementary to the shape of the jack lifting head 78 and includes interlocking features that engage complementary features on the jack lifting head. The jack lifting pad 130 is made of a durable rigid polymer material and is solid throughout the lifting pad 130.

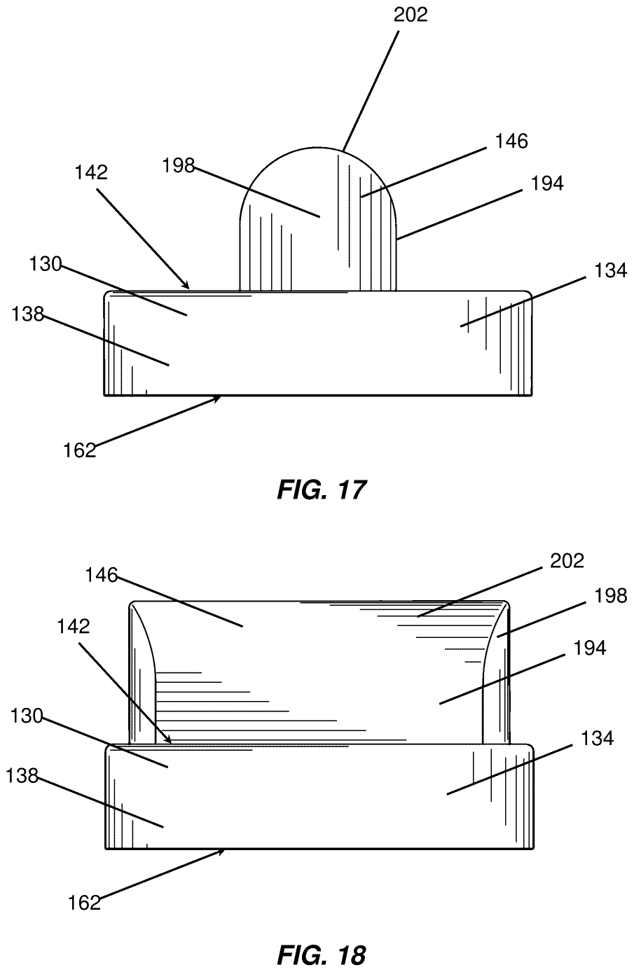

FIG. 17 shows a side view of the jack lifting pad 130. The drawing illustrates the cylindrical body 134 with its cylindrical side wall 138, flat upper surface 142, and flat lower surface 162 as well as the shaped projection 146. It can be seen how the flat vertical side wall sections 194 extend vertically perpendicular to the body upper surface 142 and transition smoothly into the curved upper surface 202. The curved upper surface 202 is semi-circular in this side view. The end walls 198 are curved out of the plane of the drawing and are rounded similarly to the side face of the circular body 134. The example lifting pad 130 has the long axis of the shaped projection oriented perpendicular to the long axis of the jack recess 166. The left side and the right side of the lifting pad 130 are the same as the lifting pad is symmetric about the front to back and left to right mid planes. FIG. 18 shows a front view of the jack lifting pad 130 and illustrates how the end walls 198 stop short of the ends of the body 134. The front side and the back side of the example lifting pad 130 are the same.

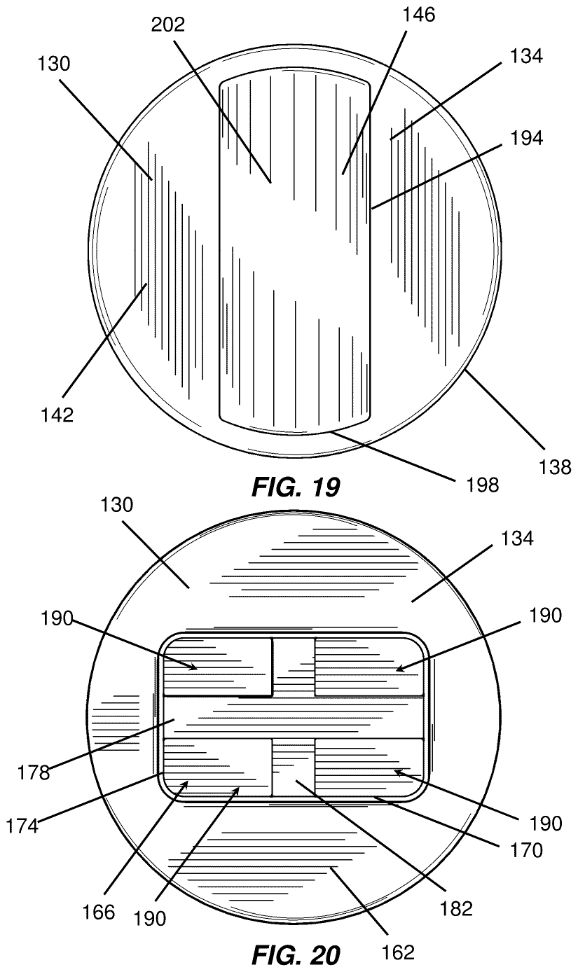

FIG. 19 shows a top view of the jack lifting pad 130, illustrating how the end walls 198 of the shaped projection 146 extend parallel to and are offset inwardly from the side wall 138 of the cylindrical body 134. The flat upper surface 142 forms a broad area for supporting the vehicle and the shaped projection 146 engages the vehicle lifting point recess to prevent the lifting pad from shifting position relative to the vehicle. FIG. 20 shows a bottom view of the jack lifting pad 130 and the interlocking jack recess 166 that receives the jack lifting head. The jack recess 166 receives the jack lifting head 78 in a close fitting mating fit.

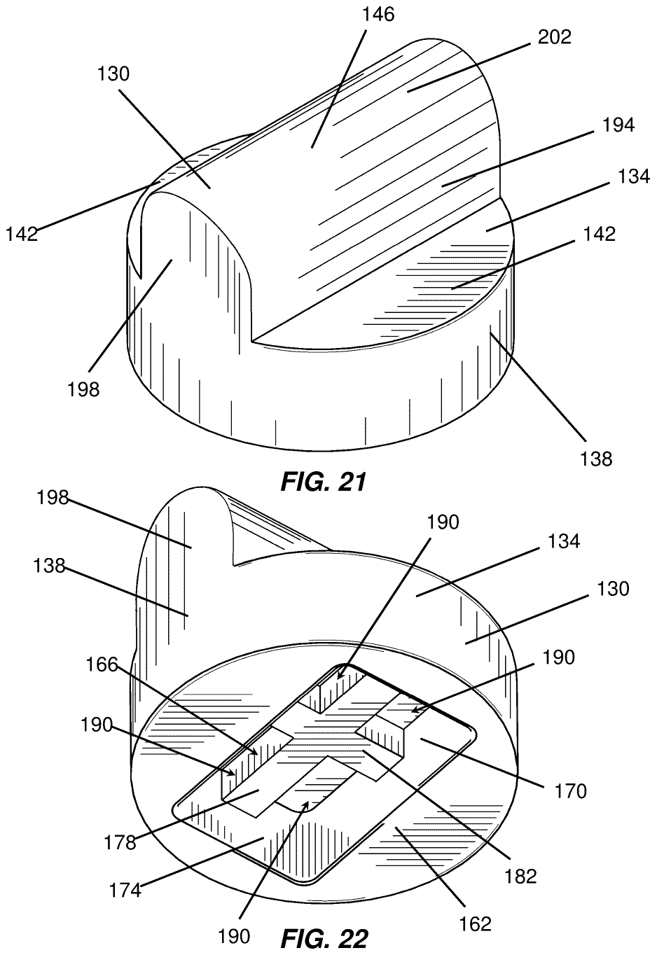

FIGS. 21 through 26 show another example jack lifting pad 130. The example lifting pad 130 is similar to the lifting pad of FIGS. 15 through 20 with the primary difference being that the shaped projection 146 has end walls that extend to be flush with the walls 138 of the cylindrical body 134. FIG. 21 shows a top perspective view of the example jack lifting pad 130. The jack lifting pad 130 is used with automobiles that are manufactured with a specialized recess at lifting points. The example lifting pad 130 includes a cylindrical body 134 that includes a cylindrical side wall 138 and a flat upper surface 142. The jack lifting pad 130 includes a shaped projection 146 that extends from the upper surface 142 of the lifting pad body 134. The shaped projection 146 is sized and configured to be matingly received into a specialized vehicle lifting point recess. The example shaped projection 146 is a rectangular projection with a horizontally arranged semi-cylindrical upper surface. The shaped projection 146 includes flat vertical side wall sections 194 and vertical end walls 198. The end walls 198 are straight in the vertical direction and are curved in the horizontal direction to create a rounded wall. The end walls 198 are curved so that they have a circular horizontal cross-section that is parallel to the circular body 134. In some examples, the end walls 198 may be flat. The shaped projection 146 includes a curved upper surface 202 that is a semi cylinder with a horizontally arranged axis. The curved upper surface is tangent to and extends smoothly from the side walls 194 and curved across the top of the shaped projection 146. In the example lifting pad 130, the shaped projection extends with its long direction perpendicular to the long direction of the interlocking jack recess 166 on the bottom of the lifting pad 130.

FIG. 22 shows a bottom perspective view of the jack lifting pad 130. The bottom of the jack lifting pad 130 has a flat lower surface 162 and an interlocking jack recess 166 that receives the jack lifting head 78 and that interlocks with the jack lifting head 78 to secure the lifting pad 130 to the jack lifting head 78. The jack recess 166 includes longitudinal side walls 170 and front and back end walls 174 that are close fitting to the jack lifting head side walls and front and back walls when the jack lifting head 78 is disposed in the jack recess 166. The jack recess 166 includes a longitudinal wall 178 and a transverse wall 182 that extend across the length of the jack recess upper end and extend downwardly from the jack recess upper surface. The longitudinal wall 178 and transverse wall 182 extend across center lines of the jack recess upper surface such that the longitudinal wall is equally spaced between the longitudinal sidewalls 170 and parallel to the side walls. Similarly, the transverse wall 182 is equally spaced between the front and back end walls 174 and is parallel to the front and back end walls 174. The longitudinal wall 178 and transverse wall 182 extend downwardly from the jack recess upper surface by the same distances and are slightly smaller in width and height than the longitudinal channel 86 and the transverse channel 90. The longitudinal wall 178 and transverse wall 182 are received in the longitudinal channel 86 and the transverse channel 90 respectively when the jack lifting pad 130 is attached to the jack lifting head 78 by inserting the jack lifting head 78 into the jack recess 166. The jack recess 166 includes four rectangular lifting recesses 190 located at the corners of the jack recess 166. The four rectangular lifting recesses 190 are separated from each other by the longitudinal wall 178 and transverse wall 182. The rectangular lifting blocks 94 are matingly received in the rectangular lifting recesses 190 when the jack lifting pad 130 is attached to the jack lifting head 78 by inserting the jack lifting head 78 into the jack recess 166. The sides of the rectangular lifting recesses 190 are positioned closely to the sides of the rectangular lifting blocks 94 to prevent movement of the jack lifting pad 130 and the top lifting surfaces 98 of the rectangular lifting blocks 94 contact the upper surfaces of the rectangular lifting recesses 190 so that the weight of the vehicle is carried by the jack lifting pad 130 and transmitted to the jack 10 by the jack lifting pad 130 and jack lifting head 78. The jack recess 166 has a shape that is complementary to the shape of the jack lifting head 78 and includes interlocking features that engage complementary features on the jack lifting head. The jack lifting pad 130 is made of a durable rigid polymer material and is solid throughout the lifting pad 130.

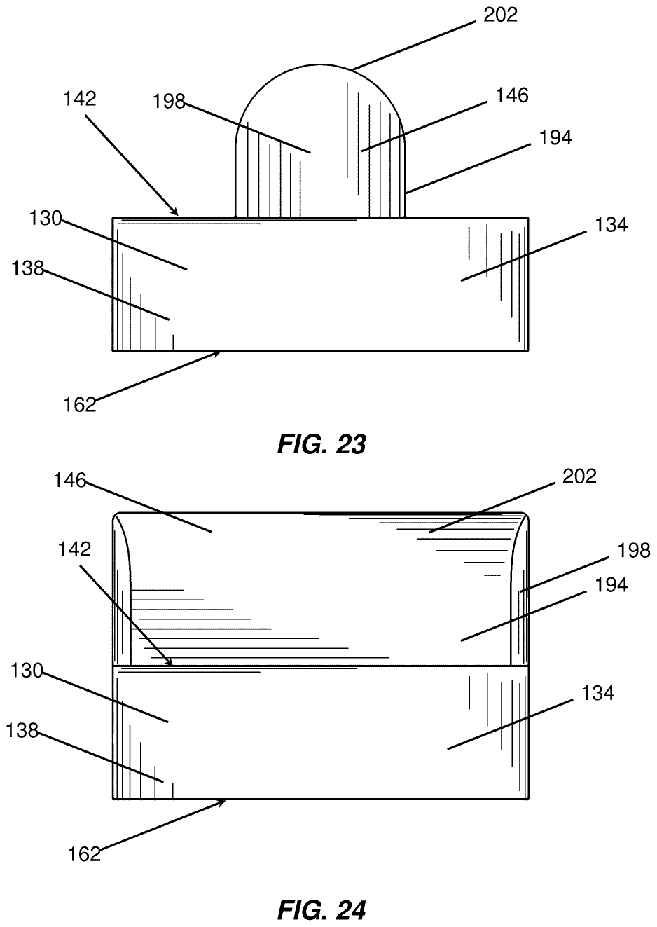

FIG. 23 shows a side view of the jack lifting pad 130. The drawing illustrates the cylindrical body 134 with its cylindrical side wall 138, flat upper surface 142, and flat lower surface 162 as well as the shaped projection 146. It can be seen how the flat vertical side wall sections 194 extend vertically perpendicular to the body upper surface 142 and transition smoothly into the curved upper surface 202. The curved upper surface 202 is semi-circular in this side view. The end walls 198 are curved out of the plane of the drawing and are rounded similarly to the side face of the circular body 134. The example lifting pad 130 has the long axis of the shaped projection oriented perpendicular to the long axis of the jack recess 166. The left side and the right side of the lifting pad 130 are the same as the lifting pad is symmetric about the front to back and left to right mid planes. FIG. 24 shows a front view of the jack lifting pad 130 and illustrates how the end walls 198 stop short of the ends of the body 134. The front side and the back side of the example lifting pad 130 are the same.

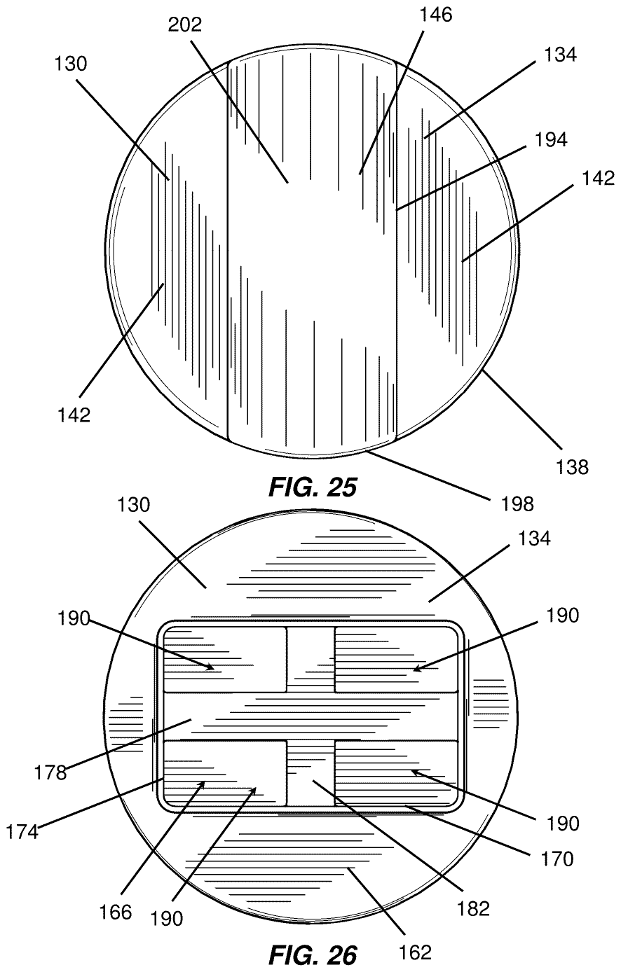

FIG. 25 shows a top view of the jack lifting pad 130, illustrating how the end walls 198 of the shaped projection 146 extend parallel to and are offset inwardly from the side wall 138 of the cylindrical body 134. The flat upper surface 142 forms a broad area for supporting the vehicle and the shaped projection 146 engages the vehicle lifting point recess to prevent the lifting pad from shifting position relative to the vehicle. FIG. 26 shows a bottom view of the jack lifting pad 130 and the interlocking jack recess 166 that receives the jack lifting head. The jack recess 166 receives the jack lifting head 78 in a close fitting mating fit.

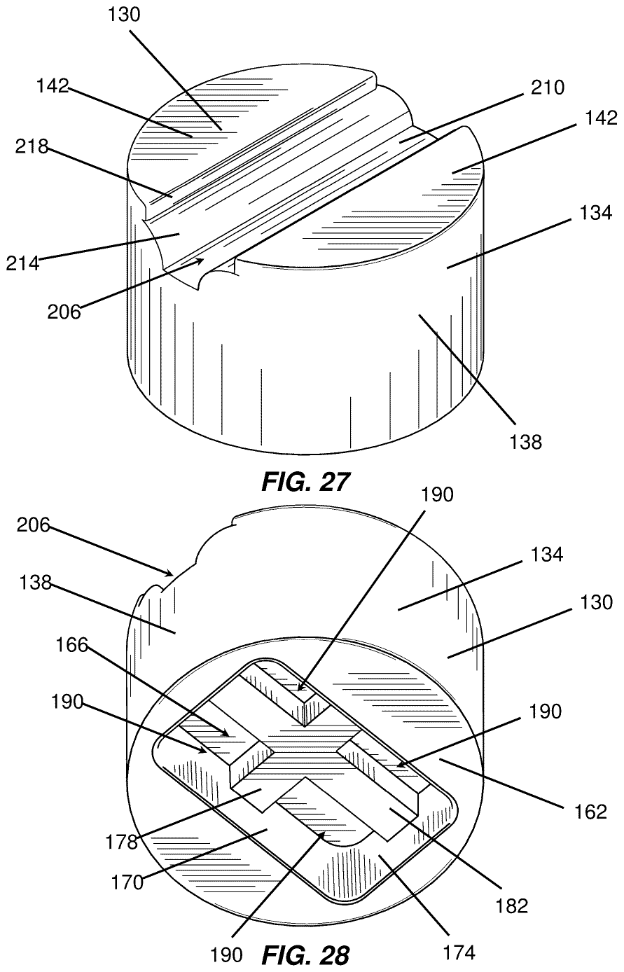

FIGS. 27 through 32 show another example jack lifting pad 130 which is designed to lift along frame rails and other lifting points. FIG. 27 shows a top perspective view of the example jack lifting pad 130. The jack lifting pad 130 is used with many different automobiles and can provide increased contact with frame rails and cross member lifting points to lift a vehicle without placing undue stress on the lifting point. The example lifting pad 130 includes a cylindrical body 134 that includes a cylindrical side wall 138 and a flat upper surface 142. The jack lifting pad 130 includes a shaped lifting channel 206 that extends across the upper surface 142 of the lifting pad body 134 between front and back ends of the lifting pad 130. The shaped lifting channel 206 is sized and configured to receive a vehicle lifting point on a frame or cross member. The example shaped lifting channel 206 extends horizontally across the top surface 142 of the lifting pad 130 and is about 10 mm deep. The shaped lifting channel includes a flat bottom 210 that is about 9 mm wide, convex curved longitudinal side wall sections 214 that extend upwardly and outwardly from the flat bottom 210 that are semi-circular with a radius that is about 6 mm or about 7 mm, and vertical side wall sections 218 that extend upwardly from the curved wall sections 214 with a width of about 22 mm between the vertical walls 214. The shaped lifting channel 206 will guide a pinch weld or cross member vertical wall into the shaped lifting channel 206 and will keep the vehicle frame portion contained within the shaped lifting channel while the vehicle is being lifted by the jack 10. The vertical wall sections 218 terminate at the flat upper lifting surface 142 of the lifting pad 130. In the example lifting pad 130, the shaped lifting channel 206 extends with its long direction parallel to and aligned with the long direction of the interlocking jack recess 166 on the bottom of the lifting pad 130.

FIG. 28 shows a bottom perspective view of the jack lifting pad 130. The bottom of the jack lifting pad 130 has a flat lower surface 162 and an interlocking jack recess 166 that receives the jack lifting head 78 and that interlocks with the jack lifting head 78 to secure the lifting pad 130 to the jack lifting head 78. The jack recess 166 includes longitudinal side walls 170 and front and back end walls 174 that are close fitting to the jack lifting head side walls and front and back walls when the jack lifting head 78 is disposed in the jack recess 166. The jack recess 166 includes a longitudinal wall 178 and a transverse wall 182 that extend across the length of the jack recess upper end and extend downwardly from the jack recess upper surface. The longitudinal wall 178 and transverse wall 182 extend across center lines of the jack recess upper surface such that the longitudinal wall is equally spaced between the longitudinal sidewalls 170 and parallel to the side walls. Similarly, the transverse wall 182 is equally spaced between the front and back end walls 174 and is parallel to the front and back end walls 174. The longitudinal wall 178 and transverse wall 182 extend downwardly from the jack recess upper surface by the same distances and are slightly smaller in width and height than the longitudinal channel 86 and the transverse channel 90. The longitudinal wall 178 and transverse wall 182 are received in the longitudinal channel 86 and the transverse channel 90 respectively when the jack lifting pad 130 is attached to the jack lifting head 78 by inserting the jack lifting head 78 into the jack recess 166. The jack recess 166 includes four rectangular lifting recesses 190 located at the corners of the jack recess 166. The four rectangular lifting recesses 190 are separated from each other by the longitudinal wall 178 and transverse wall 182. The rectangular lifting blocks 94 are matingly received in the rectangular lifting recesses 190 when the jack lifting pad 130 is attached to the jack lifting head 78 by inserting the jack lifting head 78 into the jack recess 166. The sides of the rectangular lifting recesses 190 are positioned closely to the sides of the rectangular lifting blocks 94 to prevent movement of the jack lifting pad 130 and the top lifting surfaces 98 of the rectangular lifting blocks 94 contact the upper surfaces of the rectangular lifting recesses 190 so that the weight of the vehicle is carried by the jack lifting pad 130 and transmitted to the jack 10 by the jack lifting pad 130 and jack lifting head 78. The jack recess 166 has a shape that is complementary to the shape of the jack lifting head 78 and includes interlocking features that engage complementary features on the jack lifting head. The jack lifting pad 130 is made of a durable rigid polymer material and is solid throughout the lifting pad 130.

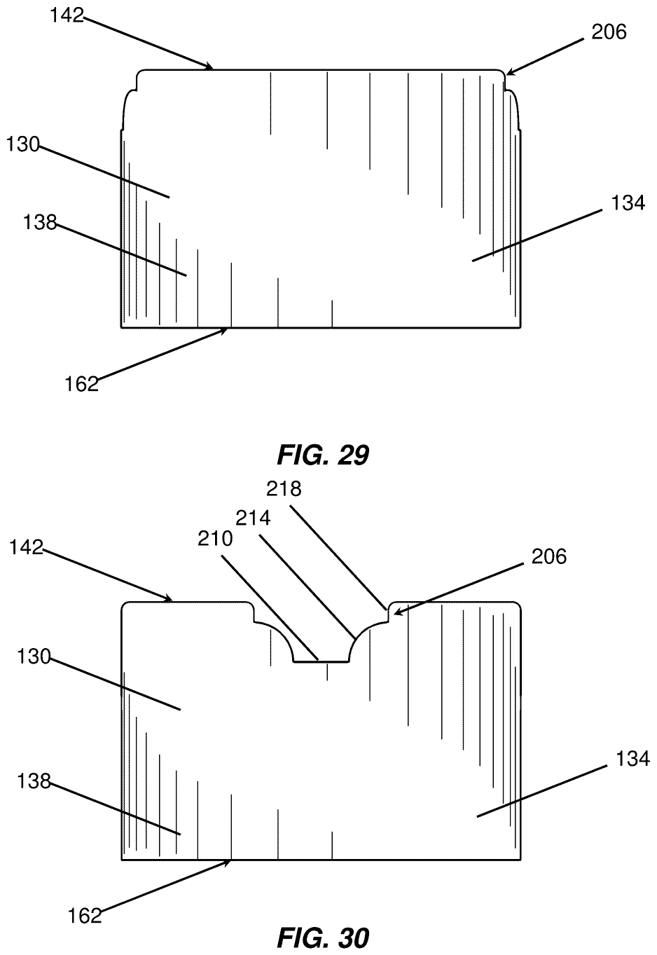

FIG. 29 shows a side view of the jack lifting pad 130. The drawing illustrates the cylindrical body 134 with its cylindrical side wall 138, flat upper surface 142, and flat lower surface 162 and illustrates how the shaped lifting channel 206 extends laterally through the top of the lifting pad 130. The left side and the right side of the lifting pad 130 are the same as the lifting pad is symmetric about the front to back and left to right mid planes. FIG. 30 shows a front view of the jack lifting pad 130 and illustrates how shaped lifting channel 206 extends through the lifting pad 130. The left and right sides of the shaped lifting channel 206 are symmetrical to each other and the shaped lifting channel 206 includes the flat horizontal bottom wall 210, the convex curved side wall sections 214 extending up and outwardly from the bottom 210, and the vertical wall sections 218. The convex wall sections 214 have a quarter circle shape and extend vertically upward from the channel bottom 210 at their bottom ends, curve outwardly by about 90 degrees, and extend horizontally and outwardly at their upper ends. The vertical wall sections 218 extend vertically upwardly from the horizontal upper ends of the curved wall sections 214. The front side and the back side of the example lifting pad 130 are the same.

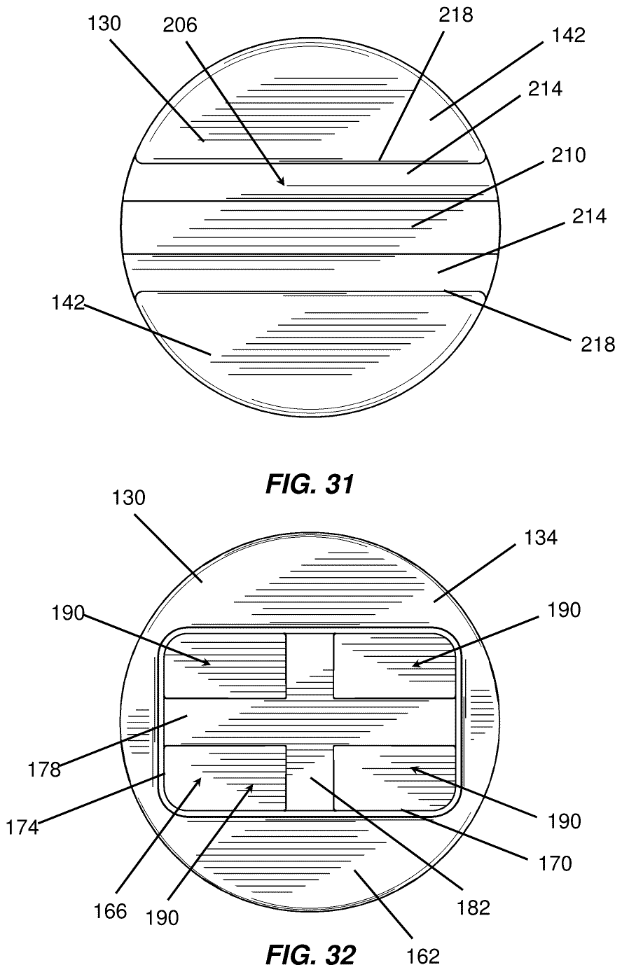

FIG. 31 shows a top view of the jack lifting pad 130, illustrating how the shaped lifting channel 206 extends parallel to the jack recess 166. The flat upper surface 142 forms a broad area for supporting the vehicle and the shaped lifting channel 206 engages the vehicle lifting point to prevent the lifting pad 130 from shifting position relative to the vehicle. FIG. 32 shows a bottom view of the jack lifting pad 130 and the interlocking jack recess 166 that receives the jack lifting head. The jack recess 166 receives the jack lifting head 78 in a close fitting mating fit.

The jack lifting head 78 safely and securely lifts a variety of vehicles by the manufacture intended lifting point recesses or frame rail locations. The lifting head properly supports the vehicle lifting point and avoids damage to the vehicle that may often occur with other temporary vehicle jacks. The lifting pads 130 allow a person to use the same jack with other lifting locations on a vehicle including those that use specialized lifting point recesses, increasing the versatility of the jack. The user may use the jack lifting head 78 with and without the lifting point pads 130 to lift the vehicle by different locations as needed. The lifting pads 130 interlock with the lifting head 78 to allow their use without decreasing the safety of using the jack 10 as would otherwise occur should a person stack objects on a jack to lift a vehicle. The jack lifting head 78 and lifting pads 130 provide increased versatility in using a vehicle jack 10 while simultaneously increasing the safety in using the jack.

The above description of illustrated examples of the present invention, including what is described in the Abstract, is not intended to be exhaustive or to be limiting to the precise forms disclosed. While specific examples of the invention are described herein for illustrative purposes, various equivalent modifications are possible without departing from the broader scope of the present claims. Indeed, it is appreciated that specific example dimensions, materials, etc., are provided for explanation purposes and that other values may also be employed in other examples in accordance with the teachings of the present invention.

What is claimed is:

1. A vehicle lifting jack system comprising:
a jack comprising a lower base configured to support the jack on a surface;
an upper jack lifting head;
a lifting mechanism operable to move the jack lifting head away from the base to thereby raise a vehicle vertically away from the ground;
wherein the jack lifting head comprises a longitudinal channel which extends along the upper surface of the jack lifting head between opposing ends of the jack lifting head, and wherein the longitudinal channel is open to the opposing ends of the jack lifting head;
wherein the jack lifting head comprises a first lifting block on a first side of the longitudinal channel and a second lifting block on a second side of the longitudinal channel;
wherein the first lifting block comprises solid material between a base of the jack lifting head and an upper surface of the first lifting block, wherein the upper surface of the first lifting block is configured to contact a vehicle and support the vehicle when the vehicle is lifted by the jack; and
wherein the second lifting block comprises solid material between a base of the jack lifting head and an upper surface of the second lifting block, wherein the upper surface of the second lifting block is configured to contact a vehicle and support the vehicle when the vehicle is lifted by the jack; and
a lifting pad which is selectively attachable to the jack lifting head;
wherein the lifting pad comprises a lower surface having an interlocking jack recess which receives the jack lifting head and which is a mating shape that interlocks with the jack lifting head to attach the lifting pad to the jack lifting head and to stabilize the lifting pad relative to the jack lifting head; and
wherein the lifting pad comprises an upper shaped lifting feature that is specifically shaped and configured to engage a lifting point on a vehicle to support the vehicle when the vehicle is lifted by the jack; and
wherein the jack is selectively operably to lift a vehicle by engaging the vehicle with the jack lifting head or to lift a vehicle by attaching the lifting pad to the jack lifting head and engaging the vehicle with the lifting pad.

2. The vehicle lifting jack system of claim 1, wherein the interlocking jack recess comprises a rectangular recess having a longitudinal wall extending between opposing ends of the interlocking jack recess, and wherein the longitudinal wall is received into the jack lifting head longitudinal channel when the lifting pad is attached to the jack lifting head.

3. The vehicle lifting jack system of claim 1, wherein the jack lifting head comprises a transverse channel which extends along the upper surface of the jack lifting head between opposing sides of the jack lifting head in a direction perpendicular to the longitudinal channel, and wherein the interlocking jack recess comprises a rectangular recess having a longitudinal wall extending between opposing ends of the interlocking jack recess and a transverse wall that extends between opposing sides of the interlocking jack recess in a direction perpendicular to the longitudinal wall, and wherein the longitudinal wall is received into the jack lifting head longitudinal channel and the transverse wall is received into the jack lifting head transverse channel when the lifting pad is attached to the jack lifting head.

4. The vehicle lifting jack system of claim 3, wherein the interlocking jack recess comprises a first recess, a second recess, a third recess, and a fourth recess each separated from each other by the longitudinal wall and the transverse wall, and wherein the lifting jack head comprises a third lifting block and a fourth lifting block, and wherein the first lifting block, the second lifting block, the third lifting block, and the fourth lifting block are received into the first recess, the second recess, the third recess, and the fourth recess respectively.

5. The vehicle lifting jack system of claim 1, wherein the upper shaped lifting feature comprises a shaped projection that is configured to matingly engage a shaped lifting recess on a vehicle to support the vehicle and a flat upper surface that is configured to engage a vehicle lifting location to support the vehicle.

6. A vehicle lifting jack system comprising:
a jack comprising a lower base configured to support the jack on a surface;
an upper lifting portion;
a lifting mechanism operable to move the upper lifting portion away from the base to thereby raise a vehicle vertically away from the ground;
wherein the upper lifting portion comprises a jack lifting head;
wherein the jack lifting head comprises a longitudinal channel which extends along the upper surface of the jack lifting head between opposing ends of the jack lifting head, and wherein the longitudinal channel is open to the opposing ends of the jack lifting head;
wherein the longitudinal channel is configured to receive a vehicle lifting point pinch weld and support the vehicle pinch weld while a vehicle is lifted by the jack;
wherein the jack lifting head comprises a first lifting block on a first side of the longitudinal channel and a second lifting block on a second side of the longitudinal channel;
wherein the first lifting block comprises solid material between a base of the jack lifting head and an upper surface of the first lifting block, wherein the upper surface of the first lifting block is configured to contact a vehicle and support the vehicle when the vehicle is lifted by the jack; and
wherein the second lifting block comprises solid material between a base of the jack lifting head and an upper surface of the second lifting block, wherein the upper surface of the second lifting block is configured to contact a vehicle and support the vehicle when the vehicle is lifted by the jack.

7. The vehicle lifting jack system of claim 6, wherein the jack lifting head comprises a transverse channel which extends along the upper surface of the jack lifting head between opposing sides of the jack lifting head in a direction perpendicular to the longitudinal channel, and wherein the transverse channel is open to the opposing sides of the jack lifting head, and wherein the longitudinal channel is configured to receive a vehicle lifting point pinch weld and support the vehicle pinch weld while a vehicle is lifted by the jack.

8. The vehicle lifting jack system of claim 7, wherein the jack lifting head comprises the first lifting block, the second lifting block, a third lifting block, and a fourth lifting block, and wherein each of the first lifting block, the second lifting block, the third lifting block, and the fourth lifting block are separated from each other by the longitudinal channel and the transverse channel.

9. The vehicle lifting jack system of claim 6, wherein the upper surface of the first lifting block comprises a textured surface having gripping cups formed therein and wherein the upper surface of the second lifting block comprises a textured surface having gripping cups formed therein.

10. The vehicle lifting jack system of claim 6, wherein the jack upper lifting portion comprises a top lifting bracket having a flat upper surface, wherein the jack lifting head comprises a flat lower surface, and wherein the jack lifting head is attached to the top lifting bracket with the lower surface adjacent the top lifting bracket upper surface.

11. The vehicle lifting jack system of claim 7, wherein the longitudinal channel has a depth which is the same as a depth of the transverse channel.

12. The vehicle lifting jack system of claim 6, wherein the jack lifting head has a length which is about 5 cm and a width which is about 3 cm.

13. The vehicle lifting jack system of claim 6, further comprising a lifting pad which is selectively attachable to the jack lifting head;
wherein the lifting pad comprises a lower surface having an interlocking jack recess which receives the jack lifting head and which is a mating shape that interlocks with the jack lifting head to attach the lifting pad to the jack lifting head and to stabilize the lifting pad relative to the jack lifting head; and
wherein the lifting pad comprises an upper shaped lifting feature that is specifically shaped and configured to engage a lifting point on a vehicle to support the vehicle when the vehicle is lifted by the jack.

14. The vehicle lifting jack system of claim 13, wherein the upper shaped lifting feature comprises a shaped projection that is configured to matingly engage a shaped lifting recess on a vehicle to support the vehicle and a flat upper surface that is configured to engage a vehicle lifting location to support the vehicle.

15. The vehicle lifting jack system of claim 13, wherein the upper shaped lifting feature comprises a shaped lifting channel that is configured to engage a lifting location on a vehicle.

16. The vehicle lifting jack system of claim 15, wherein the shaped lifting channel comprises a flat bottom surface, an intermediate wall section that extends upwardly and outwardly from the bottom surface, and an upper wall section that extends upwardly away from the intermediate wall section to a flat upper surface of the lifting pad.

17. The vehicle lifting system of claim 13, wherein the lifting pad comprises a cylindrically shaped body and wherein the interlocking jack recess extends upwardly into a bottom of the body.

18. The vehicle lifting jack system of claim 13, wherein the interlocking jack recess comprises a rectangular recess having a longitudinal wall extending between opposing ends of the interlocking jack recess, and wherein the longitudinal wall is received into the jack lifting head longitudinal channel when the lifting pad is attached to the jack lifting head.

19. The vehicle lifting jack system of claim 13, wherein the jack lifting head comprises a transverse channel which extends along the upper surface of the jack lifting head between opposing sides of the jack lifting head in a direction perpendicular to the longitudinal channel, and wherein the interlocking jack recess comprises a rectangular recess having a longitudinal wall extending between opposing ends of the interlocking jack recess and a transverse wall that extends between opposing sides of the interlocking jack recess in a direction perpendicular to the longitudinal wall, and wherein the longitudinal wall is received into the jack lifting head longitudinal channel and the transverse wall is received into the jack lifting head transverse channel when the lifting pad is attached to the jack lifting head.

20. The vehicle lifting jack system of claim 19, wherein the interlocking jack recess comprises a first recess, a second recess, a third recess, and a fourth recess each separated from each other by the longitudinal wall and the transverse wall, and wherein the lifting jack head comprises a third lifting block and a fourth lifting block, and wherein the first lifting block, the second lifting block, the third lifting block, and the fourth lifting block are received into the first recess, the second recess, the third recess, and the fourth recess respectively.
